(19) United States
(12) Patent Application Publication
(10) Pub. No.: US 2008/0222899 A1
(43) Pub. Date: Sep. 18, 2008

(54) PICTURE FRAME BACKING PAPER EDGE TRIMMER

(76) Inventor: Lamoyne W. Durham, Saline, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/687,013

(22) Filed: Mar. 16, 2007

(51) Int. Cl. B26B 29/06

(52) U.S. Cl. 30/291

(57) ABSTRACT

A tool for trimming the excess backing material on a picture frame having a back surface and a side surface comprises a hand-held body having a forward portion, a rearward portion, and a bottom guide plate configured for sliding engagement with the back surface of the picture frame. An edge guide is configured for sliding engagement against the side surface of the picture frame, and a cutting blade having a tip is spaced apart from the edge guide. The tip of the blade extends slightly below the guide plate to cut through backing material as a user moves the tool along the frame. The cutting blade may be supported in a spring-biased pivoting holder, and an engagement member is included having a first, unpushed position wherein the pivoting holder is restrained with the tip of the blade above the guide plate, and a second, pushed position wherein the pivoting holder is allowed to pivot between from a retraced position and an extended position as a function of the spring biasing.

### FIELD OF THE INVENTION

This invention relates generally to picture framing and, in particular, to a tool for trimming excess backing material applied to the back of a picture frame.

### BACKGROUND OF THE INVENTION

In the picture-framing industry, it is common to apply backing material to the back of the frame, particularly if the frame is wooden. Ordinarily, a bead of adhesive is applied around the back surface of the frame, and a backing material, such as craft paper, is adhered thereto. The backing material is larger than the frame, requiring that it be trimmed, usually along a line just inside the outer periphery of the frame itself.

There are existing implements for this purpose. FIG. 1 shows a prior-art device, in the form of a pen-shaped body 2 having a blade 6 which is spaced apart from a surface 8. The blade is interchangeable through a knob 4. In use, as shown in the figure, a user runs the device along the side of a picture frame, such that the surface 8 rides against each side surface, such as 12, thereby trimming excess material 14.

A somewhat improved version of the device of FIG. 1 is described and claimed in U.S. Pat. No. 5,060,385. Here, the blade B held in position with a screw S, provides a longer surface 11, which also operates in sliding engagement against the side of the picture frame, as shown. The problem with the devices of FIGS. 1 and 2 is that the various surfaces are quite small, resulting in a trimming process which is unpredictable and, in many cases, unsatisfactory. Not only is the trim line often wavy due to lack of control, but worse, if the blade slips, the side of the frame may be marred, requiring retouch. Clearly, any implement in which would assist in this process would be welcome by the picture-framing industry.

### SUMMARY OF THE INVENTION

This invention resides in a tool for trimming the excess backing material on a picture frame having a back surface and a side surface. In a basic configuration the tool comprises a hand-held body having a forward portion, a rearward portion, and a bottom guide plate configured for sliding engagement with the back surface of the picture frame. An edge guide provides for sliding engagement against the side surface of the picture frame, and a cutting blade having a tip is spaced apart from the edge guide. The tip of the blade extends slightly below the guide plate to cut through backing material as a user moves the tool along the frame.

In the preferred embodiment, the cutting blade is supported in a spring-biased pivoting holder, and an engagement member is included having a first position wherein the pivoting holder is restrained with the tip of the blade above the guide plate, and a second position wherein the pivoting holder is allowed to pivot between from a retraced position and an extended position as a function of the spring biasing. A first set screw is provided for adjusting the extent of the retraced position, and a second set screw is provided for adjusting the force of the spring biasing.

Although the invention is specifically directed to trimming a backing material from a picture frame, it will be apparent that the tool is useful in any other situation where backing material must be trimmed at a slight distance from an outer peripheral surface.

### BRIEF DESCRIPTION OF THE DRAWINGS

FIG. 1 is a drawing that shows the way in which an existing pen-shaped implement is used to trim backing material from a picture frame;

FIG. 2 is a drawing that shows a different implement for trimming backing material, described in U.S. Pat. No. 5,060,385;

FIG. 3 is a top-down view of a user operating the preferred embodiment of this invention;

FIG. 4 is a top-down view of the inventive trimmer, not covered by a user's hand;

FIG. 5 is a front view of the preferred embodiment, better illustrating the glide plate and edge guide;

FIG. 6 is a side view of the preferred embodiment and partial cross-section showing the blade holder in a retracted, unlocked position;

FIG. 7 is a side view drawing and partial cross-section of the preferred embodiment showing the blade holder being released, allowing to “float” from a fully retracted to a fully extended position while biased by a torsion spring;

FIG. 8 is a drawing which shows what happens when the implement is applied to a work surface in the condition of FIG. 7;

FIG. 9 is a front-view drawing that shows how the guide plate may be angled relative to the cutting blade to trim material closer to the peripheral edge of the frame, particularly if wood grain is pronounced; and

FIG. 10 is an alternative embodiment of the invention which does not utilize a release mechanism, such that the blade and holder are always “floating”; and

FIG. 11 is a further alternative embodiment of the invention, wherein the blade is fixed for a predetermined depth without a pivoting blade holder.

### DETAILED DESCRIPTION OF THE PREFERRED EMBODIMENTS

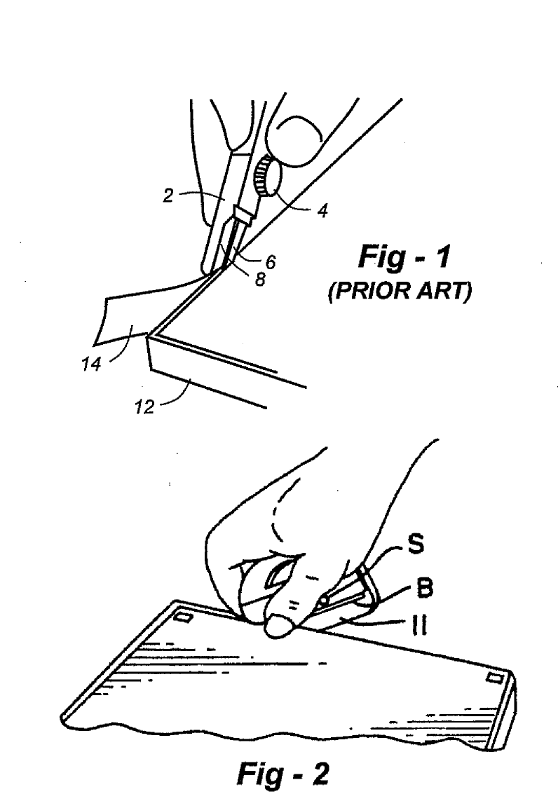

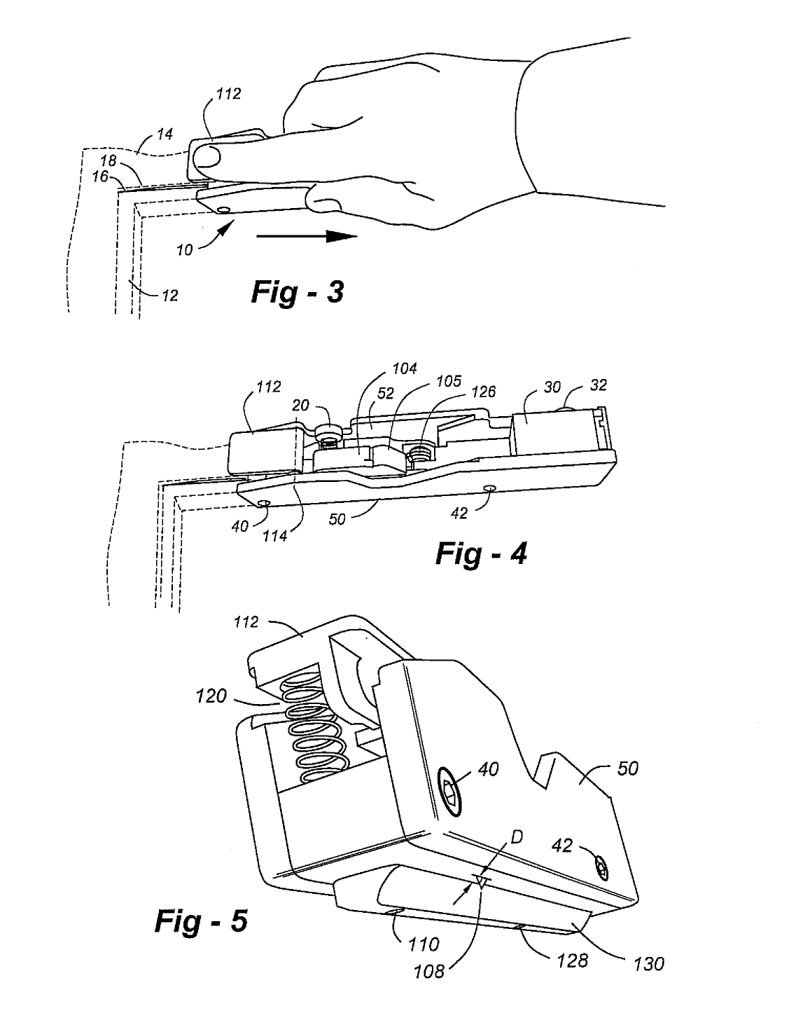

Having discussed the prior art of FIGS. 1 and 2, the reader's attention is now directed to FIG. 3, which is a top-down oblique view of a user operating the preferred embodiment of the invention, depicted generally at 10. The user has pressed an engagement lever 112, allowing a blade (not visible in this figure), to trim backing material 14 from frame 12. The user is pulling the device 10 in the direction of the arrow. As will be described in greater detail below, this results in a trim cut 16 spaced-apart at a distance from the side of the frame 18, as shown.

FIG. 4 is a top-down oblique-view drawing of the preferred embodiment, with the user's hand removed, better illustrating certain inner workings of the device. The engagement lever 112 pivots about an axis 114. The blade is held in a pivoting blade holder 105, with the blade proper being held in a housing 104 and engaged in a holder 105 through spring-biased release 20. Note that the quick-release blade holder is an option, in that a screw or bolt may alternatively be used to hold the blade on a pivoting plate.

The body of the device is made up of two side panels 50, 52, which are held together through a central portion by way of side hex screws 40, 42. The torsion spring biasing the blade and holder is indicated at 126. As a further option, a spare blade holder 30 may be provided in a rearward portion of the device, held in position with a thumbscrew 32.

FIG. 5 is a front-view drawing of the invention, showing how engagement lever 112 is biased using coil spring 120. The tip 108 of the blade is seen protruding through the bottom of the glide plate, at a spaced-apart distance from the closest edge of the edge guide 130. While the edge guide 130 may form a 90 degree angle relative to the plane of the blade, it has been found that an angle greater than 90 degrees provides for greater control. Items 110 and 128 show where the set screws are accessible to adjust the depth of cut and blade force, respectively.

FIG. 6 is a side view drawing and partial cross-section showing the way in which the various elements interact in the preferred embodiment. The engagement lever 112, pivoting about axis 114, includes a bottom lip 116 that interacts with an upper lip 118 on the pivoting blade holder 104. Likewise, a portion of the body includes an upper lip 122 which interacts with a lower lip 124 of the pivoting blade holder 104. The coil spring bias in the engagement lever 112, in the position shown, is indicated at 120. The glide plate is shown at 102, and the edge guide is shown at 130. Set screw 110 adjusts the extension of the blade described below, thereby adjusting the depth of cut in conjunction with the force applied by spring 126, the strength of which is adjusted by set screw 128.

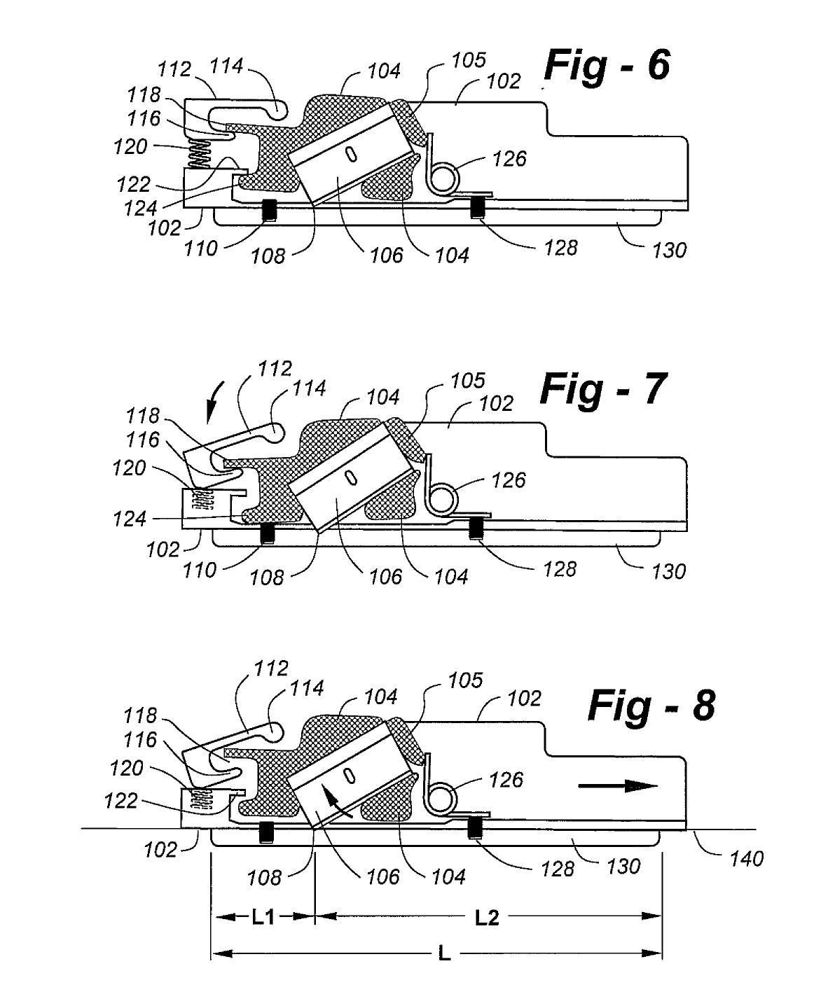

Note in FIG. 6 that the blade is maintained in a fully retracted position despite the force applied by spring 126, due to the engagement of components 116, 118 and 122, 124. However, when a user presses the engagement lever 112, as shown in FIG. 3, the blade and holder are now free to “float” from a fully retracted position to a fully extended position, shown in FIG. 7. In other words, pressing the engagement wire allows the blade to pivot downwardly to its fullest extent, stopped only by the forward set screw 110. This occurs due to the pressure applied by the torsion spring 126. In FIG. 7, although the blade has been released such that the tip 108 extends below the surface of the guide plate 102, it is not yet cutting any material.

In FIG. 8, the tool in the condition of FIG. 7 is now pulled over a picture frame with material 140 to be trimmed, with the glide plate 102 bearing against the backmost surface of the picture frame, and with the edge guide in sliding engagement with the side of the frame. Based upon the hardness of the backing material and, to a greater extent the wood or other material underlying the backing material, and further in conjunction with the setting of torsion spring 126, the blade and holder typically move up slightly relative to the condition shown in FIG. 7, thereby achieving a desired, consistent depth of cut.

One reason why the tool perform so well is that the overall distance of the glide plate and/or edge guide “L” is several inches, preferably 6 inches, as depicted in FIG. 8. This allows the distance from the front of the implement to be over an inch in length, and the distance from the tip of the blade to the back of the tool to exceed two inches, preferably 4.5 inches. This allows the tool to slide fro a few inches before cutting, such that when cutting commences, a straight, controlled accurate cut is virtually guaranteed.

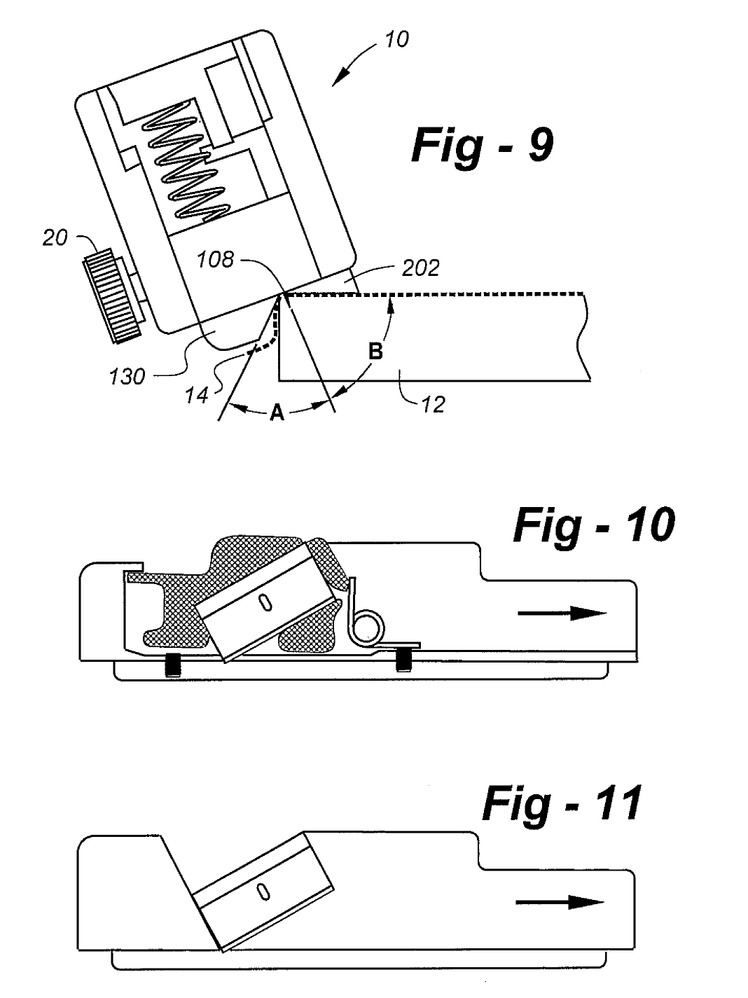

FIG. 9 is a front-view drawing that shows how the guide plate may be angled relative to the cutting blade to trim material closer to the peripheral edge of the frame, particularly if wood grain is pronounced. Wedge 202, providing an angle “B” of 70 degrees relative to the plane of the blade. This wedge, in combination with edge guide 130 providing an angle “A” of 45 degrees relative to the plane of the blade, produces a consistent, accurate cut of 0.020″ form the edge of the frame, even with softer woods. While it has been determined that these angles provide optimal results in most circumstances, the invention is not limited in this regard.

Although the preferred embodiment includes an engagement lever, allowing the blade to be maintained in a safe, retracted condition until actually used, the alternative embodiment of FIG. 10 allows the blade and holder to float in the condition shown in FIGS. 7 and 8, but without the engagement lever. Thus, the tip of the blade would always remain below the surface of the glide plate, but a somewhat more simplified construction would be achieved. Indeed, even the set screws shown in FIG. 10 could be eliminated, though at the sacrifice in performance.

An even more simplified embodiment is shown in FIG. 11, wherein the blade is simply installed with the tip at a fixed distance below the bottom of the glide plate, without any spring biasing. Although this would not work as well in all situations compared to the preferred embodiment, it would still operate better than the prior-art devices shown in FIGS. 1 and 2. The reason is that, even without the spring-biased blade holder and other conveniences of the preferred embodiment, the length of the tool overall, being 3 inches or greater, in conjunction with the greater distances between the front of the edge guide and the tip of the blade, and the tip of the blade back to the back of the edge guide, more control and consistent results would be achieved, compared to the much smaller sliding surfaces of the prior art devices.

1. A tool for trimming the excess backing material on a picture frame having a back surface and a side surface, the tool comprising:
a hand-held body having a forward portion, a rearward portion, and a bottom guide plate configured for sliding engagement with the back surface of the picture frame;
an edge guide configured for sliding engagement against the side surface of the picture frame; and
a cutting blade having a tip spaced apart from the edge guide and extending slightly below the guide plate to cut through backing material as a user moves the tool along the frame.

2. The tool of claim 1, wherein the cutting blade is supported in a spring-biased pivoting holder.

3. The tool of claim 2, further including:
an engagement member having a first position wherein the pivoting holder is restrained with the tip of the blade above the guide plate, and
a second position wherein the pivoting holder is allowed to pivot between from a retraced position and an extended position as a function of the spring biasing.

4. The tool of claim 37 further including a set screw for adjusting the extent of the retraced position.

5. The tool of claim 3, further including a set screw for adjusting the force of the spring biasing.

6. The tool of claim 1, wherein the edge guide forms and angle relative to the plane of the blade.

7. The tool of claim 1, wherein the edge guide forms and angle of 45 degrees, more or less, relative to the plane of the blade.

8. The tool of claim 1, wherein the distance between the tip of the blade and the rearward portion of the body is two inches or greater.

9. A tool for trimming the excess backing material on a picture frame having a back surface and a side surface, the tool comprising:
a hand-held body having a forward portion, a rearward portion, and a bottom guide plate configured for sliding engagement with the back surface of the picture frame;
an edge guide configured for sliding engagement against the side surface of the picture frame;
a cutting blade having a tip supported in a spring-biased holder that pivots between a retraced position, wherein the tip of the blade is above the guide plate, and an extended position, wherein the tip extends slightly below the guide plate at a spaced-apart distance from the edge guide.

10. The tool of claim 9, further including a set screw for adjusting the extent of the retraced position.

11. The tool of claim 9, further including a set screw for adjusting the force of the spring biasing.

12. The tool of claim 9, further including:
an engagement member having a first position wherein the pivoting holder is held in the retraced position, and
a second position wherein the pivoting holder is allowed to pivot between the retraced position and the extended position as a function of the spring biasing.

13. The tool of claim 9, wherein the angle formed between the edge guide and the plane of the blade is in the range of 0 to 60 degrees.

14. The tool of claim 9, wherein the distance between the forward portion of the body and the tip of the blade is one inch or greater.

15. The tool of claim 9, further including a wedge placing the blade at an angle relative to the back surface of the frame.
